(19) United States
(12) Patent Application Publication
(10) Pub. No.: US 2013/0171459 A1
(43) Pub. Date: Jul. 4, 2013

(54) POLYAMIC ACID RESIN SOLUTION CONTAINING INTERPENETRATING POLYMER AND LAMINATE USING THE SAME

(71) Applicants: Tsung-Hsiung WANG, Dali City (TW); Jing-Pin PAN, Chutung Chen (TW); Jung-Mu HSU, Magong City (TW)

(72) Inventors: Tsung-Hsiung WANG, Dali City (TW); Jing-Pin PAN, Chutung Chen (TW); Jung-Mu HSU, Magong City (TW)

(21) Appl. No.: 13/595,753

(22) Filed: Aug. 27, 2012

(30) Foreign Application Priority Data
Dec. 29, 2011 (TW) 100149466

(51) Int. Cl. C09D 179/08; B32B 15/08

(52) U.S. Cl. 428/458; 524/548; 524/600

(57) ABSTRACT

Provided is a polyamic acid resin solution containing interpenetrating polymer. The solution includes a polyamic acid resin dissolved in a solvent. The polyamic acid resin includes an interpenetrating polymer formed of polyamic acid twining around hyper-branched polybismaleimide. The hyper-branched polybismaleimide includes a bismaleimide polymer, a bismaleimide oligomer, a barbituric acid-bismaleimide copolymer or combinations thereof.

All related applications are incorporated by reference. The present application is based on, and claims priority from, Taiwan (International) Application Serial Number No. 100149466, filed on Dec. 29, 2011, the disclosure of which is hereby incorporated by reference herein in its entirety.

### BACKGROUND

1. Technical Field

The present disclosure relates to a polyamic acid resin composition. More particularly, the present disclosure relates to a polyamic acid resin composition having good thermal and dimensional stability with good adhesion to a metal substrate.

2. Description of the Related Art

Polyimide is a material widely used in various industrial applications. In particular, in the electronics industry, the polyimide may be coated onto a metal substrate to form a laminate for the use of its good thermal stability and electrical insulation. For example, the laminate may be used as a flexible printed circuit (FPC) which may be provided for forming various electronic features thereon.

The FPC, in particular, a polyimide/metal double-layered FPC, may be formed by (a) coating a polyamic acid resin on a metal substrate and (b) performing a baking process. Since the removal of solvents and the dehydration-condensation reaction of transforming the polyamic acid resin to the polyimide are carried out by heating, the double-layered FPC may have problems of substrate warpage, poor structural toughness and poor adhesion between the double layers due to thermal stress effects resulting from different thermal expansion coefficients between the polyimide film and the metal substrate.

In order to resolve these problems, many techniques have been disclosed. For example, the linear thermal stability and the bonding strength of the polyimide may be improved by adding by adding 10%˜50% of tertiary amine compounds into the polyamic acid resin or by forming a copolymer of polyimide and 6-amino-2-(p-aminophenyl)-benzimidazole. However, the above methods would result in an increased production cost and a rigorous synthesis condition. Moreover, an organic/inorganic composite film formed of polyimide and silica nanoparticles has been also approached. The organic/inorganic composite film can has good transparency, good mechanical strength, a high glass transition temperature and a low thermal expansion coefficient. However, silica is an inorganic material which has a relatively heavier weight than the organics and could possibly lower the insulation performance of the polyimide film.

As illustrated above, to modify the polyamic acid resin is the most effective and rapid way to improve the performance of polyimide/metal double-layered laminate. The above methods of modifying the polyamic resin can be summarized as follows: forming a polyamic acid resin solution from diamine monomer and dianhydride monomer; and then adding modifying agents or inorganic additions to the polyamic acid resin solution with optionally performing a modifying reaction to form a modified polyamic acid resin or an inorganic doped polyamic acid resin, is obtained. That is, in the conventional methods, the modification is carried out after the polyamic acid resin has been formed. However, the performance of the polyamic acid resin cannot be significantly improved by using the conventional methods. Accordingly, a method which is easy to perform and can significantly improve the performance of the polyamic acid resin is needed.

### SUMMARY

One object of the present disclosure is to provide a polyamic acid resin solution containing interpenetrating polymer, the solution including: a polyamic acid resin dissolved in a solvent, the polyamic acid resin comprising an interpenetrating polymer formed of polyamic acid twining around hyper-branched polybismaleimide, wherein the hyper-branched polybismaleimide comprises a bismaleimide polymer, a bismaleimide oligomer, a barbituric acid-bismaleimide copolymer, or combinations thereof.

Still another object of the present disclosure is to provide a laminate, including: a metal substrate; and a polyimide film coated on the metal substrate, wherein the polyimide film is formed by coating the polyamic acid resin solution described above onto the metal substrate and performing a thermal baking.

### BRIEF DESCRIPTION OF THE DRAWINGS

The invention will now be described, by way of example, with reference to the accompanying drawings, in which:

FIG. 1 illustrates a flow chart of forming a polyamic resin composition containing an interpenetrating polymer in accordance with an embodiment of the present disclosure;

FIG. 2 illustrates a flow chart of forming a polyamic resin composition containing an interpenetrating polymer in accordance with another embodiment of the present disclosure; and

FIG. 3 illustrates a laminate in accordance with an embodiment of the present disclosure.

FIG. 4 shows a comparison scheme of a bismaleimide monomer solution in NMP and the 5 wt % polybismaleimide solution in NMP, analyzed using a gel penetration chromatograph (GPC).

### DETAILED DESCRIPTION

A polyamic acid resin composition containing an interpenetrating polymer and a polyimide/metal laminate formed thereof in accordance with exemplary embodiments of the present disclosure are provided. In embodiments of the present disclosure, a proper ratio of a diamine monomer and an anhydride monomer with a proper ratio are added to and dissolved in a hyper-branched polybismaleimide solution and thoroughly mixed for carrying out a polymerization of the diamine monomer and the anhydride monomer. In the embodiments of the present disclosure, the polybismaleimide may comprise a bismaleimide polymer, a bismaleimide oligomer, a barbituric acid-bismaleimide copolymer or combinations thereof. The hyper-branched polybismaleimide may have many nano-scaled pores and cages. The diamine monomer and the dianhydride monomer may enter into these nano-scaled pores and cages and carry out in-situ reaction of forming the polyamic acid. Thus, an interpenetrating polymer may be formed of the hyper-branched polybismaleimide and the in-situ formed polyamic acid. In addition, the interpenetrating polymer may be used to improve the structural strength, toughness, and thermal and dimensional stability of a polyimide film.

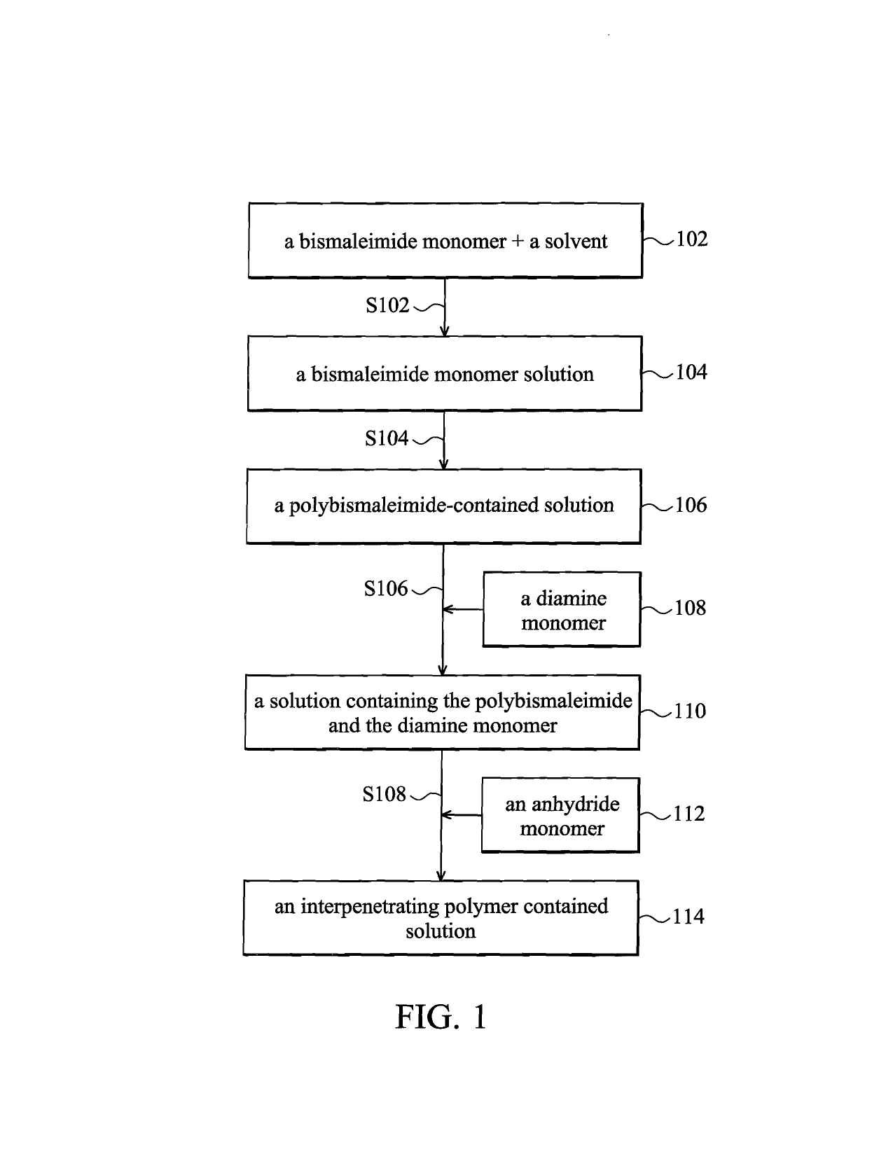

Referring to FIG. 1, illustrated is a flow chart of forming a polyamic resin composition containing an interpenetrating polymer in accordance with an embodiment of the present disclosure. Referring to block 102, a bismaleimide monomer and a solvent are provided first. Then, performing step S102, the bismaleimide monomer is added into the solvent and thoroughly mixed for a complete dissolution. The product of block 104, the bismaleimide monomer solution 104, may be formed. In an embodiment, the bismaleimide monomer may have the following formulas, such as Formula (I) or Formula (II):

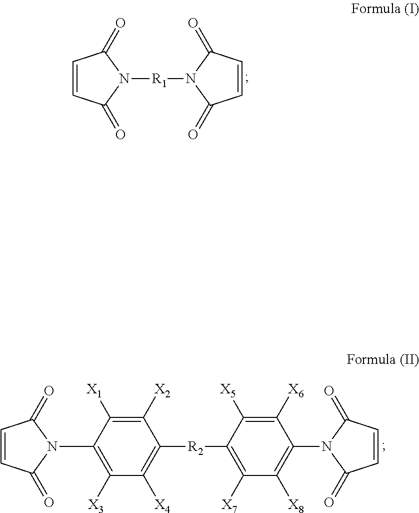

wherein the R1 group of the Formula (I) is: —RCH₂—R—, —R—NH₂—R—, —C(O)—, —C(O)CH₂—, —CH₂OCH₂—, —C(O)—, —R—C(O)—R—, —O—, —O—O—, —S—, —S—S—, —S(O)—, —R—S(O)—R—, —(O)S(O)—, —R—(O)S(O)—R—, —C₆H₄—, —R—(CH₄)—R—, —R(C₆H₄)(O)—, —(C₆H₄)—(C₆H₄)—, —R—(C₆H₄)—(C₆H₄)—R, or —R—(C₆H₄)—(C₆H₄)—O—, wherein the R₂ group of the Formula (II) is: —R—, —O—, —O—O—, —S—, —S—S—, —C(O)—, —S(O)—, or —(O)S(O)—, wherein the “R” is a C₁₋₈ alkyl group, the “C₆H₄” is a phenyl group, the “(C₆H₄)—(C₆H₄)” is a biphenyl group, and the X₁ to X₈ groups may be independently selected from halogens, hydrogen, a C₁₋₈ alkyl group, a C₁₋₈ cycloalkyl group, or a C₁₋₈ alkylsilane group.

For example, the bismaleimide monomer may be selected from the group consisting of N,N′-bismaleimide-4,4′-diphenylmethane, 1,1′-(methylenedi-4,1-phenylene)bismaleimide, N,N′-(1,1′-biphenyl-4,4′-diyl)bismaleimide, N,N′-(4-methyl-1,3-phenylene)bismaleimide, 1,1′-(3,3′dimethyl-1,1′-biphenyl-4,4′-diyl)bismaleimide, N,N′-ethylenedimaleimide, N,N′-(1,3-phenylene)dimaleimide, N,N′-thiodimaleimide, N,N′-dithiodimaleimide, N,N′-ketonedimaleimide, N,N′-methylene-bis-maleinimide, bis-maleinimidomethyl ether, 1,2-bis-(maleimido)-1,2-ethandiol, N,N′-4,4′-diphenylether-bis-maleimide and 4,4′-bis(maleimido)-diphenylsulfone.

The solvent may be any of several solvents capable of dissolving the bismaleimide, such as N-methyl-2-pyrrolidone (NMP), N—N-dimethylformamide (DMF), dimethylacetamide (DMAc), pyrrolidone, N-dodecylpyrrolidone, γ-butylrolactone and other suitable organic solvents.

Then, performing step S104, the bismaleimide monomer solution 104 is heated and stirred such that the bismaleimide monomer dissolved in the solution 104 begins to polymerize to hyper-branched polybismaleimide. The product of block 106, a polybismaleimide-contained solution 106, may be formed. For example, the polymerization reaction may be carried out at a temperature ranging from about 40° C. to 150° C. for 6 to 96 hours. The hyper-branched polybismaleimide may have a hyper-branched structure with many nano-scaled pores and/or cages formed therein. In this embodiment, the hyper-branched polybismaleimide may be a polybismaleimide polymer having a weight average molecular weight of about 50,000 to 1,500,000, or a polybismaleimide oligomer having a weight average molecular weight of about 5,000 to 50,000. In an embodiment, the hyper-branched polybismaleimide may have an average size of about 10 to 50 nm.

Continues to perform step S106. The reactant of block 108, a diamine monomer, is added to and dissolved in the polybismaleimide-contained solution 106. The product of block 110, a solution 110 containing the polybismaleimide and the diamine monomer, is formed. The diamine monomer may comprise p-phenyl diamine, m-phenyl diamine, trifluoromethyl-2,4-diaminobenzene, trifluoromethyl-3,5-diaminobenzene, 2,5-dimethyl-1,4-phenylenediamine (DPX), 2,2-bis-(4-aminophenyl)propane, 4,4′-diaminophenyl, 4,4′-diaminobenzophenone, 4,4′-diaminophenylmethane, 4,4′-diaminophenyl sulfide, 4,4′-diaminophenyl sulfone, 3,3′-diaminophenyl sulfone, bis-(4-(4-aminophenoxy)phenyl sulfone (BAPS), 4,4′-bis-(aminophenoxy)biphenyl (BAPB), 4,4′-diaminodiphenyl ether, 3,4′-diaminodiphenyl ether, 2,2-bis-(3-aminophenyl)propane, N,N-bis-(4-aminophenyl)-n-butylamine, N,N-bis-(4-aminophenyl)methylamine, 1,5-diaminonaphthalene, 3,3′-dimethyl-4,4′-diaminobiphenyl, m-amino benzoyl-p-amino aniline, 4-aminophenyl-3-aminobenzoate, N,N-bis-(4-aminophenyl)aniline), 2,4-diaminotoluene, 2,5-diaminotoluene, 2,6-diaminotoluene, 2,4-diamine-5-chlorotoluene, 2,4-diamine-6-chlorotoluene, 2,4-bis-(beta-amino-t-butyl)toluene, bis-(p-beta-amino-t-butyl phenyl)ether, p-bis-2-(2-methyl-4-aminopentyl)benzene, m-xylylene diamine, p-xylylene diamine, or combinations thereof.

Alternatively, the diamine monomers may comprise aryldiamines, such as 1,2-bis-(4-aminophenoxy)benzene, 1,3-bis-(4-aminophenoxy)benzene, (1,3-bis-(3-aminophenoxy)benzene, 1-(4-aminophenoxy)-3-(3-aminophenoxy)benzene, 1,4-bis-(4-aminophenoxy)benzene, 1,4-bis-(3-aminophenoxy)benzene, 1-(4-aminophenoxy)-4-(3-aminophenoxy)benzene, 2,2-bis-(4-[4-aminophenoxy]phenyl)propane (BAPP), 2,2′-bis-(4-aminophenyl)-hexafluoro propane, 2,2′-bis-(4-phenoxy aniline)isopropylidene, 2,4,6-trimethyl-1,3-diaminobenzene, 4,4′-diamino-2,2′-trifluoromethyl diphenyloxide, 3,3′-diamino-5,5′-trifluoromethyl diphenyloxide, 4,4′-trifluoromethyl-2,2′-diaminobiphenyl, 2,4,6-trimethyl-1,3-diaminobenzene, 4,4′-oxy-bis-[2-trifluoromethyl)benzene amine, 4,4′-oxy-bis-[3-trifluoromethyl)benzene amine, 4,4′-thio-bis-[(2-trifluoromethyl)benzene-amine], 4,4′-thiobis[(3-trifluoromethyl)benzene amine], 4,4′-sulfoxyl-bis-[(2-trifluoromethyl)benzene amine], 4,4′-sulfoxyl-bis-[(3-trifluoromethyl)benzene amine], 4,4′-keto-bis-[(2-trifluoromethyl)benzene amine] or combinations thereof.

Continues to perform step S108. The reactant of block 112, an anhydride monomer, is added to the solution 110 and thoroughly stirred at room temperature. The diamine monomer and the anhydride monomer are polymerized to polyamic acid. The product of block 114, an interpenetrating polymer contained solution 114, may be formed. In an embodiment, the diamine monomer and the anhydride monomer may have a molar ratio of between about 2:3 and about 3:2. It should be noted that steps S106 and S108 may be carried out under N₂ environment.

The anhydride monomer may comprise 3,3′,4,4′-benzophenone tetracarboxylic dianhydride, 3,3′,4,4′-biphenyltetracarboxylic dianhydride, pyromellitic dianhydride (PMDA), 4,4′-oxydiphthalic anhydride (ODPA), 3,3′,4,4′-diphenylsulfonetetracarboxylic dianhydride (DSDA), 2,2′-bis(3,4-dicarboxyphenyl)hexafluoropropane dianhydride), 1,2,4,5-benzenetetracarboxylic-1,2:4,5-dianhydride, 1,4,5,8-naphthalene tetracarboxylic dianhydride (NTDA), perylene-3,4,9,10-tetracarboxylic acid dianhydride (PTCDA), 2,6-bis(3,4-dicarboxyphenoxy)naphthalene dianhydride, 2,7-bis(3,4-dicarboxyphenoxy)naphthalene dianhydride, 4,4′-biphthalic dianhydride or combinations thereof.

Each of the diamine monomer and the dianhydride monomer has a size of merely about 1 Å, which is far less than the diameter (10˜50 nm) of the polybismaleimide and the free volume constituting the pores and cages within the polybismaleimide. The diamine monomer and dianhydride monomer may freely penetrate into the nano-scaled pores and cages within the hyper-branched polybismaleimide, and even in close to the core of the hyper-branched structure. Thus, the diamine monomer and the dianhydride monomer may be in situ reacted in the nano-scaled pores and cages, and the polyamic acid may be formed twinning around the hyper-branched polybismaleimide. A polyamic acid resin containing the interpenetrating polymer may be formed, wherein the interpenetrating polymer may be constituted of the polyamic acid and the hyper-branched polybismaleimide. In an embodiment, the interpenetrating polymer may be a full-interpenetrating polymer. In an embodiment, the hyper-branched polybismaleimide may be 0.1 wt %˜50 wt %, or 1 wt %˜20 wt % of the total weight of the solid content of the polyamic acid resin.

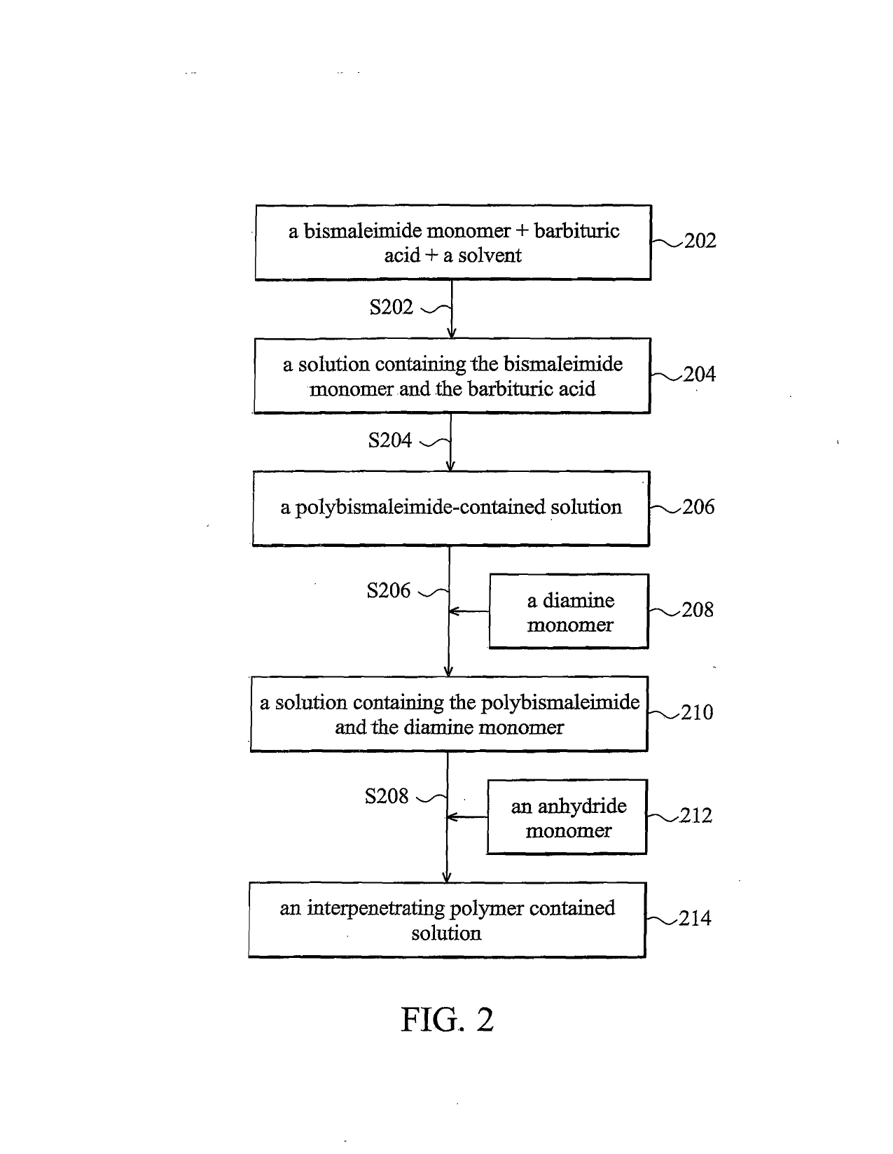

Referring to FIG. 2, illustrated is a flow chart of forming a polyamic resin composition containing an interpenetrating polymer in accordance with another embodiment of the present disclosure.

First, referring to block 202, a bismaleimide monomer, barbituric acid and a solvent are provided. Continues to perform step S202, the bismaleimide monomer and the barbituric acid are added to the solvent with thorough stirring. The product of block 204, a solution 204 containing the bismaleimide monomer and the barbituric acid, is formed. In this embodiment, the bismaleimide monomer and the solvent may be the same with the preceding embodiments. The barbituric acid may have a structural formula as per the following:

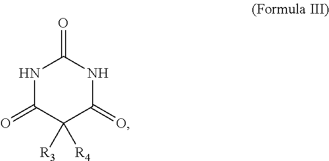

wherein R3 and R4 may be selected from hydrogen, methyl, phenyl, isopropyl, isobutyl and isopentyl. The barbituric acid and the bismaleimide may have a molar ratio of between about 1:1 and about 1:50.

Continues to perform step S204. The solution 204 is heated and thoroughly stirred such that the bismaleimide monomer and the barbituric acid are polymerized to hyper-branched polybismaleimide. The product of block 206, a polybismaleimide contained solution 206, may be formed. In an embodiment, the solution 204 may be heated to 40° C. to 150° C. and stirred for 6 to 96 hours. In this embodiment, the hyper-branched polybismaleimide may be a barbituric acid-bismaleimide copolymer. The barbituric acid-bismaleimide copolymer may have an average size of 10 to 50 nm and a weight average molecular weight of about 50,000 to 1,5000,000. The barbituric acid-bismaleimide copolymer may have a hyper-branched structure having many nano-scaled pores and cages therein.

Continues to perform step S206. The reactant of block 208, a diamine monomer, is added to the polybismaleimide contained solution 206 with thorough stirring. The product of block 210, a solution 210 containing the polybismaleimide and the diamine monomer, may be formed. In this embodiment, the diamine monomer may be the same with the preceding embodiments.

Next, continues to perform step S208. The reactant of block 212, an anhydride monomer, is added to the solution 210 and thoroughly stirred at room temperature such that the anhydride monomer and the diamine monomer are polymerized to form polyamic acid resin. The product of block S212, a solution 212 containing the polyamic acid resin, may be formed. Similar to the preceding embodiments, the polyamic acid resin may comprise an interpenetrating polymer constituted of the polyamic acid and the hyper-branched polybismaleimide. In an embodiment, the diamine monomer and the anhydride monomer may have a molar ratio of about 2:3 to about 3:2. It should be noted that the steps S306 and S308 may be carried out under N₂ environment. In this embodiment, the same anhydride monomer with the preceding embodiments may be used.

Each of the diamine monomer and the dianhydride monomer has a size of merely about 1 Å, which is far less than the diameter (10-50 nm) of the polybismaleimide and the free volume constituting the pores and cages within the polybismaleimide. The diamine monomer and dianhydride monomer may freely penetrate into the nano-scaled pores and cages within the hyper-branched polybismaleimide, and even in close to the core of the hyper-branched structure. Thus, the diamine monomer and the dianhydride monomer may be in situ reacted in the nano-scaled pores and cages, and the polyamic acid may be formed twinning around the hyper-branched polybismaleimide. A polyamic acid resin containing the interpenetrating polymer may be formed, wherein the interpenetrating polymer may be constituted of the polyamic acid and the hyper-branched polybismaleimide. In an embodiment, the interpenetrating polymer may be a full-interpenetrating polymer. In an embodiment, the hyper-branched polybismaleimide may be 0.1 wt %-50 wt %, or 1 wt %-20 wt % of the total weight of the solid content of the polyamic acid resin.

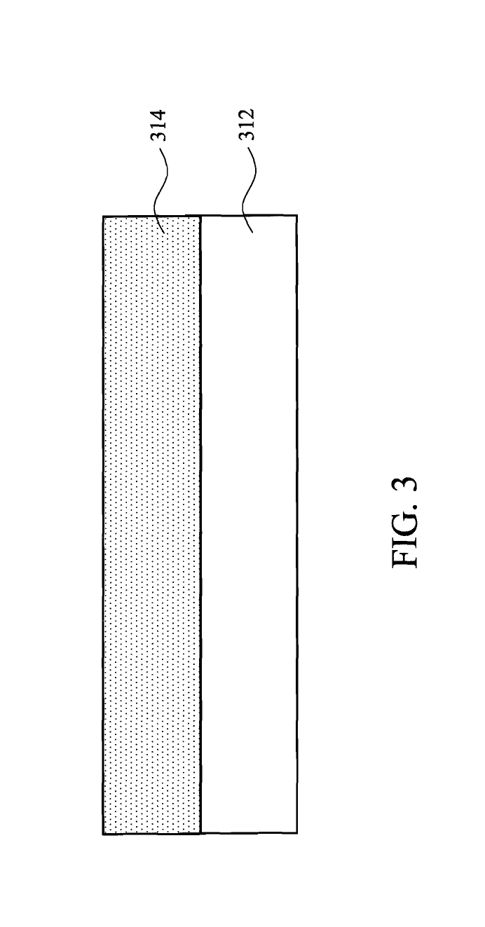

Referring to FIG. 3, the interpenetrating polymer contained solution 114 and/or 214 (referred to as a mixed solution hereinafter) according to the steps illustrated in FIG. 1 and FIG. 2 may be coated to a metal substrate 312. A laminate structure constituted of a polyimide film 314 and the metal substrate 312 may be formed.

The metal substrate 312 may comprise Cu foils, Cu—Cr alloy, Cu—Ni alloy, Cu—Ni—Cr alloy, Al alloys or combinations thereof. The metal substrate 312 may have a thickness of about 5 to 50 μm. The metal substrate 312 may have a thermal coefficient of about 15 to 25 ppm/° C. The coating method may be blade coating, spin coating, curtain coating, slot die coating or the like. For instance, the polyimide film may be polymerized from the precursors such as polyamic acid. The polymerization step may comprise: (a) coating the mixed solution onto the metal substrate 312 by the blade coating or the slot die coating; and (b) heating the coating to remove the solvents and promote the reaction of the polyamic acid.

Since the polyimide film 314 may be formed by the dehydration of the polyamic acid resin containing the interpenetrating polymer, the polyimide film may have better thermal and dimensional stability. In an embodiment, the polyimide film may have a glass transition temperature of higher than about 300° C., which is at least 20° C. higher than that of a pure polyimide film. The polyimide film 314 may have an average thermal expansion coefficient (between 30° C. and 250° C.) of between about 18 and 21 ppm/° C., which is similar to that of the polyimide film doped with silica.

In addition, the terminals of the hyper-branched polybismaleimide may be unreacted functional groups, such as unreacted double bonds. The unreacted double bonds may be chelated to the surface of the metal substrate 312, and therefore the bonding strength between the polyimide film 314 and the metal substrate 312 may be significantly enhanced. In addition, the interpenetrating structure can also enhance the film structural roughness and the film mechanical strength, such that the polyimide film may have improved structural roughness, mechanical strength, and thermal and size stability.

As summarized above, the polyimide film containing the interpenetrating polymer may have excellent thermal and size stability while preserving the advantages of organic materials, such as good electric isolation and a lighter weight. In addition, the laminate constituted of the polyimide film and the metal substrate may have not only the advantages of polyimide film, but also have high bonding strength between the polyimide film and the metal substrate. Thus, the laminate according to embodiments of the present disclosure may be widely used in various electronic components with improved performance.

The detailed steps of forming the interpenetrating polymer contained polyimide film and the laminate containing the polyimide film are illustrated in the following description.

### Example 1

13.16 g of (0.37 mole) of 4,4′-diphenylmethane bismaleimide was added to a 500 ml reaction bottle. 250 g of N-methyl pyrollidone (NMP) was added to the 500 ml reaction bottle and thoroughly stirred for completely dissolving the 4,4′-diphenylmethane bismaleimide. Then, after continued stirring at 130° C. for 48 hours under N₂ environment, a 5 wt % poly(4,4′-diphenylmethane bismaleimide) solution in NMP was obtained.

### Example 2

7.60 g (0.021 mole) of 4,4′-diphenylmethane bismaleimide and 0.14 g (0.001 mole) of barbituric acid were added to a 500 ml reaction bottle. 250 g of NMP was added to the reaction bottle and thoroughly stirred for completely dissolving the 4,4′-diphenylmethane bismaleimide and the barbituric acid. Then, after continued stirring at 130° C. for 48 hours under N₂ environment, a 3 wt % barbituric acid-4,4′-diphenylmethane bismaleimide copolymer solution in NMP was obtained.

### Example 3

44.12 g of the 5 wt % 4,4′-diphenylmethane bismaleimide solution in NMP obtained from Example 1 was added to a 500 ml reaction bottle. 208.18 g of NMP was added to the reaction bottle and stirred under N₂ environment to obtain a homogeneous solution. 12.60 g (0.070 mole) of p-phenylene diamine (p-PDA) and 3.50 g (0.018 mole) of 4,4′-oxydianiline(4,4′-ODA) were added to the above homogeneous solution and stirred under N2 environment. Then, 25.82 g of bis(phenylnene dicarboxylic acid) dianhydride (BPDA) was added to the reaction bottle in several stages, at 30-minute intervals. Then, after continued stirring for 3 hours after the BPDA was completely added to the reaction bottle, a solution-I which contains 15 wt % of poly(4,4′-diphenylmethane bismaleimide) and polyamic acid in NMP was obtained.

### Example 4

44.12 g of the 5 wt % 4,4′-diphenylmethane bismaleimide solution in NMP obtained from Example 1 was added to a 500 ml reaction bottle. 208.18 g of NMP was added to the reaction bottle and stirred under N₂ environment to obtain a homogeneous solution. 13.47 g (0.067 mole) of p-phenylene diamine (p-PDA) and 2.64 g (0.013 mole) of 4,4′-oxydianiline(4,4′-ODA) were added to the above homogeneous solution and stirred under N₂ environment. Then, 20.70 g (0.0070 mole) of bis(phenylnene dicarboxylic acid) dianhydride (BPDA) and 5.10 g (0.0016 mole) of 3,3,4,4-benzophenone tetracarboxylic dianhydride (BTDA) were added to the reaction bottle in several stages, at 30-minute intervals. Then, after continued stirring for 3 hours after the BPDA and the BTDA were completely added to the reaction bottle, a solution-II which contains 15 wt % of poly(4,4′-diphenylmethane bismaleimide) and polyamic acid in NMP was obtained.

### Example 5

147.06 g of the 3 wt % barbituric acid-4,4′-diphenylmethane bismaleimide copolymer solution in NMP obtained from Example 2 was added to a 500 ml reaction bottle. 107.35 g of NMP was added to the reaction bottle and stirred under N₂ environment to obtain a homogeneous solution. 11.93 g (0.066 mole) of p-phenylene diamine (p-PDA) and 3.32 g (0.017 mole) of 4,4′-oxydianiline (4,4′-ODA) were added to the above homogeneous solution and stirred under N₂ environment to completely dissolve the p-PDA and the 4,4′-ODA. Then, 24.46 g (0.083 mole) of bis(phenylnene dicarboxylic acid) dianhydride (BPDA) was added to the reaction bottle in several stages, at 30-minute intervals. Then, after continued stirring for 3 hours after the BPDA was completely added to the reaction bottle, a solution-III which contains 15 wt % of the barbituric acid-4,4′-diphenylmethane bismaleimide copolymer and polyamic acid in NMP was obtained.

### Example 6

73.67 g of the 3 wt % barbituric acid-4,4′-diphenylmethane bismaleimide copolymer solution in NMP obtained from Example 2 was added to a 500 ml reaction bottle. 178.54 g of NMP was added to the reaction bottle and stirred under N₂ environment to obtain a homogeneous solution. 13.47 g (0.067 mole) of p-phenylene diamine (p-PDA) and 2.64 g (0.013 mole) of 4,4′-oxydianiline (4,4′-ODA) were added to the above homogeneous solution and stirred under N₂ environment to completely dissolve the p-PDA and the 4,4′-ODA. Then, 20.707 g (0.070 mole) of bis(phenylnene dicarboxylic acid) dianhydride (BPDA) and 5.10 g (0.0016 mole) of 3,3,4,4-benzophenone tetracarboxylic dianhydride (BTDA) were added to the reaction bottle in several stages, at 30-minute intervals. Then, after continued stirring for 3 hours after the BPDA and the BTDA were completely added to the reaction bottle, a solution-IV which contains 15 wt % of the BMI-BTA copolymer and a polyamic acid in NMP was obtained.

### Example 7

The solution-I obtained from Example 3 was coated onto a copper foil substrate and baked in three stages at 120° C. for 30 mins, at 250° C. for 30 mins, and then at 350° C. for 60 mins under N₂ environment. The dehydration of the polyamic acid was carried out, and a polyimide film/copper double-layered laminate structure was formed.

### Example 8

The solution-II obtained from Example 4 was coated onto a copper foil substrate and baked in three stages at 120° C. for 30 mins, at 250° C. for 30 mins, and then at 350° C. for 60 mins under N₂ environment. The dehydration of the polyamic acid was carried out, and a polyimide film/copper double-layered laminate structure was formed.

### Example 9

The solution-III obtained from the Example 5 was coated onto a copper foil substrate and baked in three stages at 120° C. for 30 mins, at 250° C. for 30 mins, and then at 350° C. for 60 mins under N₂ environment. The dehydration of the polyamic acid was carried out, and a polyimide film/copper double-layered laminate structure was formed.

### Example 10

The solution-IV obtained from Example 6 was coated onto a copper foil substrate and baked in three stages at 120° C. for 30 mins, at 250° C. for 30 mins, and then at 350° C. for 60 mins under N₂ environment. The dehydration of the polyamic acid was carried out, and a polyimide film/copper double-layered laminate structure was formed.

### Example 11

8.34 g (0.046 mole) of p-phenylene diamine (p-PDA) and 2.32 g of 4,4′-oxydianiline (4,4′-ODA) were added to a 500 ml reaction bottle. 250 g of dimethyl acetamide (DMAC) was added to the reaction bottle and stirred under N₂ environment to completely dissolve the p-PDA and the 4,4′-ODA. Then, 21.79 g (0.074 mole) of bis(phenylnene dicarboxylic acid) dianhydride (BPDA) and 5.37 g (0.0017 mole) of 3,3,4,4-benzophenone tetracarboxylic dianhydride (BTDA) were added to the reaction bottle in several stages, at 30-minute intervals. Then, after continued stirring for 3 hours after the BPDA and the BTDA were completely added to the reaction bottle, a solution-V which contains 15 wt % of polyamic acid in DMAC was obtained.

### Example 12

14.18 g (0.079 mole) of p-phenylene diamine (p-PDA) and 2.78 g (0.014 mole) of 4,4′-oxydianiline (4,4′-ODA) were added to a 500 ml reaction bottle. 250 g of dimethyl acetamide (DMAC) was added to the reaction bottle and stirred under N₂ environment to completely dissolve the p-PDA and the 4,4′-ODA. Then, 21.79 g (0.074 mole) of bis(phenylnene dicarboxylic acid) dianhydride (BPDA) and 5.37 g (0.0017 mole) of 3,3,4,4-benzophenone tetracarboxylic dianhydride (BTDA) were added to the reaction bottle in several stages, at 30-minute intervals. Then, after continued stirring for 3 hours after the BPDA and the BTDA were completely added to the reaction bottle, a solution-VI which contains 15 wt % of polyamic acid in DMAC was obtained.

### Example 13

0.53 g of silica powder (5 wt % of the total solid content) was added to 100 g of the solution-V obtained from Example 11 and thoroughly mixed in a three-roller mill. Accordingly, a solution-VII which contains silica and polyamic acid in DMAC was obtained.

### Example 14

0.53 g of silica powder (5 wt % of the total solid content) was added to 100 g of the solution-VI obtained from Example 12 and thoroughly mixed in a three-roller mill. Accordingly, a solution-VIII which contains silica and polyamic acid in DMAC was obtained.

### Example 15

The solution-V obtained from Example 11 was coated onto a copper foil substrate and baked in three stages at 120° C. for 30 mins, at 250° C. for 30 mins, and then at 350° C. for 60 mins under N₂ environment. The polymerization of the polyamic acid was carried out, and a polyimide film/copper double-layered laminate structure was formed.

### Example 16

The solution-VI obtained from Example 12 was coated onto a copper foil substrate and baked in three stages at 120° C. for 30 mins, at 250° C. for 30 mins, and then at 350° C. for 60 mins under N₂ environment. The polymerization of the polyamic acid was carried out, and a polyimide film/copper double-layered laminate structure was formed.

### Example 17

The solution-VII obtained from Example 13 was coated onto a copper foil substrate and baked in three stages at 120° C. for 30 mins, at 250° C. for 30 mins, and then at 350° C. for 60 mins under N₂ environment. The polymerization of the polyamic acid was carried out, and a polyimide film/copper double-layered laminate structure was formed.

### Example 18

The solution-VIII obtained from Example 14 was coated onto a copper foil substrate and baked in three stages at 120° C. for 30 mins, at 250° C. for 30 mins, and then at 350° C. for 60 mins under N₂ environment. The polymerization of the polyamic acid was carried out, and a polyimide film/copper double-layered laminate structure was formed.

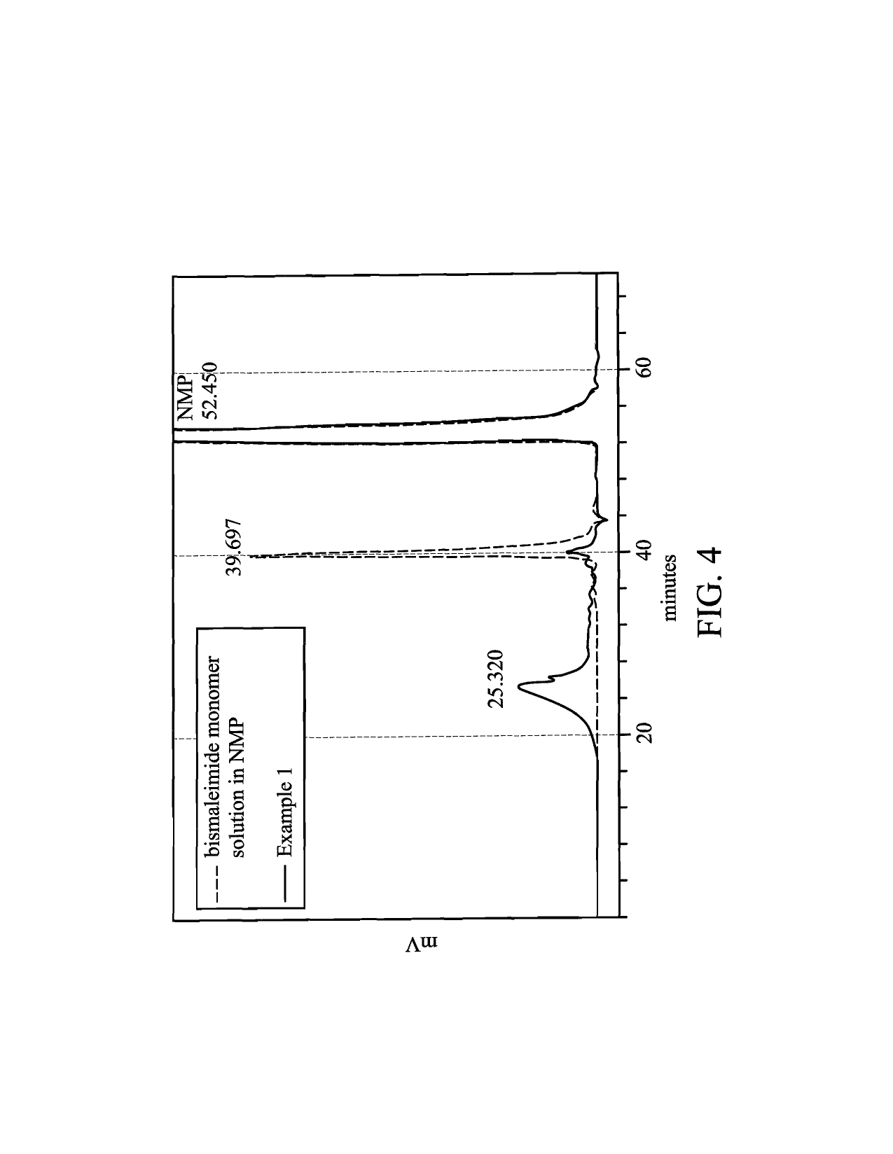

FIG. 4 shows a comparison scheme of a bismaleimide monomer solution in NMP and the 5 wt % polybismaleimide solution in NMP obtained from Example 1, analyzed using a gel penetration chromatograph (GPC). The bismaleimide monomer solution in NMP is represented by the dotted line, and the 5 wt % polybismaleimide solution in NMP obtained from Example 1 is represented by the solid line. It can be observed that the peak of the bismaleimide monomer was shown at about 40 mins, and the peak of the NMP was shown at about 52.4 mins. Most of the bismaleimide monomer had disappeared in the polybismaleimide solution obtained from Example 1, and a new peak which is suggested as the polybismaleimide was shown at about 25 mins. Accordingly, it is suggested that most of the bismaleimide monomer is polymerized to the polybismaleimide with a conversion rate of higher than 95% in the solution obtained from Example 1.

Table 1 shows the performance test results of the polyimide film/copper foil double-layered laminate structure of Examples 7-10 and 15-18.

TABLE 1

| | | Example | Example | Example | Example | Example | Example | Example | Example |
|---|---|---|---|---|---|---|---|---|---|
| | unit | 15 | 16 | 17 | 18 | 7 | 8 | 9 | 10 |
| Solid content | wt % | 0 | 0 | 5 | 5 | 5 | 5 | 10 | 5 |
| exclusive of the | | | | | | | | | |
| polyimide in the | | | | | | | | | |
| polyimide film | | | | | | | | | |
| Thickness of the | μm | 19 | 20 | 19 | 20 | 20 | 21 | 19 | 20 |
| polyimide film^{a} | | | | | | | | | |
| Glass transition | ° C. | 265 | 280 | 287 | 298 | 306 | 315 | 322 | 308 |
| temperature of | | | | | | | | | |
| the polyimide | | | | | | | | | |
| film | | | | | | | | | |
| Thermal | ppm/° C. | 37 | 35 | 21 | 20 | 22 | 21 | 19 | 21 |
| expansion | | | | | | | | | |
| coefficient | | | | | | | | | |
| between | | | | | | | | | |
| 30-250° C.^{a} | | | | | | | | | |
| Peeling | Kgf/cm | 0.86 | 0.91 | 0.85 | 0.93 | 0.92 | 0.98 | 1.18 | 0.96 |
| strength^{b} | | | | | | | | | |
| Surface flatness^{c} | — | curl | curl | flat | flat | flat | flat | flat | flat |
| (Before etching | | (>5 cm) | (>5 cm) | | | | | | |
| copper foil) | | | | | | | | | |
| Surface flatness^{c} | — | curl | curl | sightly | flat | flat | flat | flat | flat |
| (After etching | | (>5 cm) | (>5 cm) | curl | | | | | |
| copper foil) | | | | (1.5 cm) | | | | | |
| Solder thermal | — | fail | fail | pass | pass | pass | pass | pass | pass |
| stability^{d} | | | | | | | | | |
| (288° C./30 sec) | | | | | | | | | |
| Insulation | >1 × 10¹⁰Ω | pass | pass | pass | pass | pass | pass | pass | pass |
| property^{e} | | | | | | | | | |
| (insulation | | | | | | | | | |
| impendance) | | | | | | | | | |
| Insulation | >1 × 10¹³Ω | pass | pass | pass | pass | pass | pass | pass | pass |
| property^{e} | | | | | | | | | |
| (Surface | | | | | | | | | |
| resistivity)^{e} | | | | | | | | | |
| Insulation | | | | | | | | | |
| property^{e} | >1 × 10¹⁴Ω · cm | pass | pass | pass | pass | pass | pass | pass | pass |
| (Volume | | | | | | | | | |
| resistivity) | | | | | | | | | |

^{a}tested by thermal mechanical analyzer;
^{b}according to IPC-TM-650(2.4.9) standard;
^{c}cutting the laminate structure to a A4 size work piece;
^{d}according to IPC-TM-650(2.4.13) standard;
^{e}according to IPC-TM-650(2.5.17) standard.

As shown in Table 1, the polyimide films obtained from Examples 7-10 had a glass transition temperature of higher than 300° C., and even higher than that of the silica doped polyimide films (Examples 17 and 18). A significantly improved thermal stability has been shown. In addition, the thermal expansion coefficients of Examples 7-10 was merely between 19˜22 ppm/° C., which is far less than pure polyimide films of Examples 15-16 and similar to the silica doped polyimide films of Examples 17-18. When regarding other properties such as insulation properties and solder thermal stability, each of the polyimide films obtained from Examples 7-10 may pass the test, such as IPC-TM-650(2.4.9) standard and IPC-TM-650(2.5.17) standard.

In addition, a good peeling strength between the polyimide film and the copper foil substrate of the polyimide/metal laminate structure of Examples 7-10 is shown. Whether before or after etching the copper substrate, the polyimide films still had good surface flatness without curing.

While the preferred embodiments of the invention have been described above, it will be recognized and understood that various modifications can be made to the invention and the appended claims are intended to cover all such modifications which may fall within the spirit and scope of the invention.

What is claimed is:

1. A polyamic acid resin solution containing interpenetrating polymer, the solution comprising:
a polyamic acid resin dissolved in a solvent, the polyamic acid resin comprising an interpenetrating polymer formed of polyamic acid twining around hyper-branched polybismaleimide, wherein the hyper-branched polybismaleimide comprises a bismaleimide polymer, a bismaleimide oligomer, a barbituric acid-bismaleimide copolymer or combinations thereof.

2. The solution of claim 1, wherein the bismaleimide polymer and the bismaleimide oligomer are formed from a bismaleimide monomer having Formula (I) or Formula (II) as following: 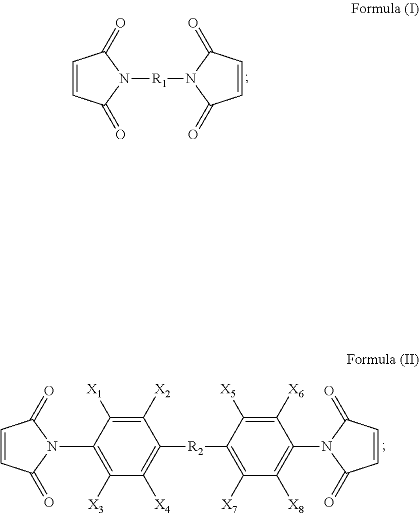
wherein the R1 group of the Formula (I) is: —RCH₂—R—, —R—NH₂—R—, —C(O)—, —C(O)CH₂—, —CH₂OCH₂—, —C(O)—, —R—C(O)—R—, —O—, —O—O—, —S—, —S—S—, —S(O)—, —R—S(O)—R—, —(O)S(O)—, —R—(O)S(O)—R—, —C₆H₄—, —R—(C₆H₄)—R—, —R(C₆H₄)(O)—, —(C₆H₄)—(C₆H₄)—R—(C₆H₄)—(C₆H₄)—R, or —R—(C₆H₄)—(C₆H₄)—O—, wherein the R₂ group of the Formula (II) is: —R—, —O—, —O—O—, —S—, —S—S—, —C(O)—, —S(O)—, or —(O)S(O)—, wherein the “R” is a C₁₋₈ alkyl group, the “C₆H₄” is a phenyl group, and the “(C₆H₄)—(C₆H₄)” is a biphenyl group, wherein the X₁ to X₈ groups are independently selected from halogens, Hydrogen, a C₁₋₈ alkyl group, a C₁₋₈ cycloalkyl group, or a C₁₋₈ alkylsilane group.

3. The solution of claim 2, wherein the barbituric acid-bismaleimide copolymer is copolymerized from the bismaleimide monomer having the Formula (I) or (II) and barbituric acid having Formula (III) as following: 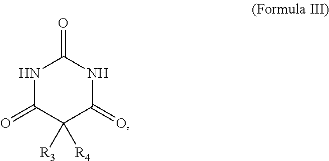
where R₃ and R₄ is selected from Hydrogen, methyl, phenyl, isopropyl, isobutyl and isopentyl.

4. The solution of claim 1, wherein the polyamic acid is polymerized from a diamine monomer and an anhydride monomer.

5. The solution of claim 4, wherein the anhydride monomer comprises 3,3′,4,4′-benzophenone tetracarboxylic dianhydride, 3,3′,4,4′-biphenyltetracarboxylic dianhydride, pyromellitic dianhydride (PMDA), 4,4′-oxydiphthalic anhydride (ODPA), 3,3′,4,4′-diphenylsulfonetetracarboxylic dianhydride (DSDA), 2,2′-bis(3,4-dicarboxyphenyl)hexafluoropropane dianhydride, 1,2,4,5-benzenetetracarboxylic-1,2:4,5-dianhydride, 1,4,5,8-naphthalene tetracarboxylic dianhydride (NTDA), perylene-3,4,9,10-tetracarboxylic acid dianhydride (PTCDA), 2,6-bis(3,4-dicarboxyphenoxy)naphthalene dianhydride, 2,7-bis(3,4-dicarboxyphenoxy)naphthalene dianhydride, 4,4′-biphthalic dianhydride or combinations thereof.

6. The solution of claim 4, wherein the diamine monomer may comprise p-phenyl diamine, m-phenyl diamine, trifluoromethyl-2,4-diaminobenzene, trifluoromethyl-3,5-diaminobenzene, 2,5-dimethyl-1,4-phenylenediamine (DPX), 2,2-bis-(4-aminophenyl)propane, 4,4′-diaminophenyl, 4,4′-diaminobenzophenone, 4,4′-diaminophenylmethane, 4,4′-diaminophenyl sulfide, 4,4′-diaminophenyl sulfone, 3,3′-diaminophenyl sulfone, bis-(4-(4-aminophenoxy)phenyl sulfone (BAPS), 4,4′-bis-(aminophenoxy)biphenyl (BAPB), 4,4′-diaminodiphenyl ether, 3,4′-diaminodiphenyl ether), 2,2-bis-(3-aminophenyl)propane, N,N-bis-(4-aminophenyl)-n-butylamine, N,N-bis-(4-aminophenyl)methylamine, 1,5-diaminonaphthalene, 3,3′-dimethyl-4,4′-diaminobiphenyl, m-amino benzoyl-p-amino aniline, 4-aminophenyl-3-aminobenzoate, N,N-bis-(4-aminophenyl)aniline), 2,4-diaminotoluene, 2,5-diaminotoluene, 2,6-diaminotoluene, 2,4-diamine-5-chlorotoluene, 2,4-diamine-6-chlorotoluene, 2,4-bis-(beta-amino-t-butyl)toluene, bis-(p-beta-amino-t-butyl phenyl)ether, p-bis-2-(2-methyl-4-aminopentyl)benzene, m-xylylene diamine, p-xylylene diamine, 1,2-bis-(4-aminophenoxy)benzene), 1,3-bis-(4-aminophenoxy)benzene), (1,3-bis-(3-aminophenoxy)benzene), (1-(4-aminophenoxy)-3-(3-aminophenoxy)benzene), 1,4-bis-(4-aminophenoxy)benzene), 1,4-bis-(3-aminophenoxy)benzene), (1-(4-aminophenoxy)-4-(3-aminophenoxy)benzene, 2,2-bis-(4-[4-aminophenoxy]phenyl)propane (BAPP), 2,2′-bis-(4-aminophenyl)-hexafluoro propane, 2,2′-bis-(4-phenoxy aniline)isopropylidene, 2,4,6-trimethyl-1,3-diaminobenzene, 4,4′-diamino-2,2′-trifluoromethyl diphenyloxide, 3,3′-diamino-5,5′-trifluoromethyl diphenyloxide, 4,4′-trifluoromethyl-2,2′-diaminobiphenyl, 2,4,6-trimethyl-1,3-diaminobenzene, 4,4′-oxy-bis-[2-trifluoromethyl)benzene amine, 4,4′-oxy-bis-[3-trifluoromethyl)benzene amine], 4,4′-thio-bis-[(2-trifluoromethyl)benzene-amine], 4,4′-thiobis[(3-trifluoromethyl)benzene amine], 4,4′-sulfoxyl-bis-[(2-trifluoromethyl)benzene amine], 4,4′-sulfoxyl-bis-[(3-trifluoromethyl)benzene amine], 4,4′-keto-bis-[(2-trifluoromethyl)benzene amine] or combinations thereof.

7. The solution of claim 1, wherein the interpenetrating polymer comprises a full-interpenetrating polymer.

8. A laminate, comprising:
a metal substrate; and
a polyimide film coated on the metal substrate, wherein the polyimide film is formed by coating the polyamic acid resin solution of claim 1 onto the metal substrate and performing a thermal baking.

9. The laminate of claim 8, wherein the bismaleimide polymer and the bismaleimide oligomer are formed from a bismaleimide monomer having Formula (I) or Formula (II) as per the following: 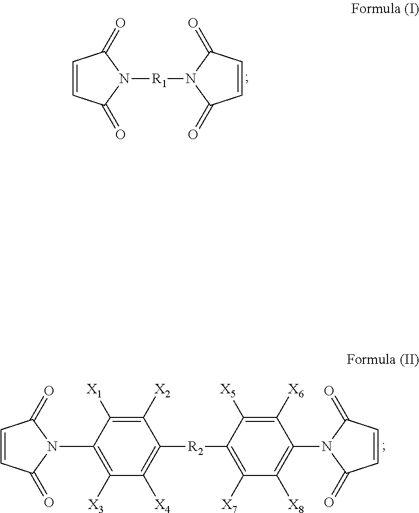
wherein the R1 group of the Formula (I) is: —RCH₂—R—, —R—NH₂—R—, —C(O)—, —C(O)CH₂—, —CH₂OCH₂—, —C(O)—, —R—C(O)—R—, —O—, —O—O—, —S—, —S—S—, —S(O)—, —R—S(O)—R—, —(O)S(O)—, —R—(O)S(O)—R—, —C₆H₄—, —R—(C₆H₄)—R—, —R(C₆H₄)(O)—, —(C₆H₄)—(C₆H₄)—, —R—(C₆H₄)—(C₆H₄)—R, or —R—(C₆H₄)—(C₆H₄)—O—, wherein the R₂ group of the Formula (II) is: —R—, —O—, —O—O—, —S—, —S—S—, —C(O)—, —S(O)—, or —(O)S(O)—, wherein the “R” is a C₁₋₈ alkyl group, the “C₆H₄” is a phenyl group, and the “(C₆H₄)—(C₆H₄)” is a biphenyl group, wherein the X₁ to X₈ groups are independently selected from halogens, Hydrogen, a C₁₋₈ alkyl group, a C₁₋₈ cycloalkyl group, or a C₁₋₈ alkylsilane group.

10. The laminate of claim 8, wherein the barbituric acid-bismaleimide copolymer is copolymerized from the bismaleimide monomer having the Formula (I) or (II) and barbituric acid having Formula (III) as per the following: 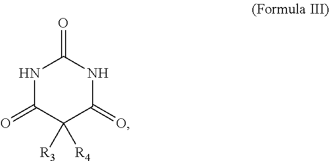
where R₃ and R₄ is selected from Hydrogen, methyl, phenyl, isopropyl, isobutyl and isopentyl.

11. The laminate of claim 8, wherein the metal substrate comprises Cu foils, Cu—Cr alloy, Cu—Ni alloy, Cu—Ni—Cr alloy, Al alloys or combinations thereof.

12. The laminate of claim 8, wherein the hyper-branched polybismaleimide is about 0.1 wt % to 50 wt % of the total weight of the polyimide film.
